(19) United States
(12) Patent Application Publication
(10) Pub. No.: US 2008/0014226 A1
(43) Pub. Date: Jan. 17, 2008

(54) METHOD OF FORMULATING AND MANUFACTURING NON-PHARMACEUTICAL COSMETIC AND PERSONAL CARE PRODUCTS

(76) Inventors: Linda J. Walker, Cardiff, CA (US); Darcy C. Taylor, Cardiff, CA (US)

Correspondence Address: Wright Law Group, PLLC;ATTN: Mark F. Wright, Suite 2, 7201 West Oakland, Chandler, AZ, 85226, US

(21) Appl. No.: 11/776,060

(22) Filed: Jul. 11, 2007

Related U.S. Application Data
(60) Provisional application No. 60/807,021, filed on Jul. 11, 2006.

(51) Int. Cl. A61Q 19/00

(52) U.S. Cl. 424/401

(57) ABSTRACT

As disclosed herein, a series of compounds that are not generally intended for internalization such as cosmetic and skin care products are formulated using chirally correct components, organic ingredients, and natural or naturally derived ingredients. In this fashion, any deleterious biological effects due to inadvertent or incidental internalization may be reduced or minimized to a greater extent. The chirally correct formulations may be used in various types of skin creams, cleansers, lotions, etc. that are formulated for application to the external surfaces of a biological entity, including humans and animals. In addition to the use of chirally correct ingredients, other formulations include additional natural and/or organic ingredients.

### CROSS REFERENCE TO RELATED APPLICATION

This application claims the benefit of the filing date for U.S. Provisional Patent Application No. 60/807,021, filed on Jul. 11, 2006, which application is now pending and which application is incorporated herein by reference.

### BACKGROUND OF THE INVENTION

1. Technical Field

The present invention relates generally to the formulation and use of various cosmetic and personal care products and more particularly relates to formulations for various compounds that may be accidentally or incidentally ingested by humans and/or animals.

2. Background Art

The cosmetic and personal care industry use many raw materials and ingredients that are made to aid in the texture, feel, smell, look, performance and longevity of products, as well as to provoke a localized “therapeutic” response/change (hence the evolvement of the so-called “dermaceutical” and “cosmeceutical” grade products) as a means of relieving or eliminating various specified skin conditions. Although the FDA regulates the types of claims cosmetic and personal care products can make regarding what they do or do not do to the skin, only moderate attention is paid to the actual physiological impact of what such products do to the skin, independent of any marketing claims.

While a good number of ingredients are legally regulated by the FDA, the bulk of existing and new ingredients are not, either because they have not been adequately medically tested, or that they just have not been in existence long enough or utilized long enough in the cosmetic and personal care industry to gather statistical safety data.

The stratum corneum (“the horny layer”) is the outermost layer of the epidermis or skin. It is composed mainly of dead cells that lack nuclei. As these dead cells slough off, they are continuously replaced by new cells from the stratum germinativum (basale). The stratum corneum has long been regarded as a reliable biological shield, limiting external agents from passing through the epidermis and into the dermis. The appendages found in the dermis, including follicles, glands, blood vessels and connective tissues, are viable gateways into the rest of the internal body, thus the importance of the stratum corneum in keeping potentially harmful external agents away from underlying cutaneous layers.

As humans and animals have passed through the ages, the stratum corneum has gone from protecting bodies from the “simple” external agents of nature (such as dirt, pathogens, plants and organisms) to more complex, reactive and rather unnatural compounds (such as artificial and industrial chemicals, drugs and medicines, man-made pollutants and manufactured compounds). However, the stratum corneum has not necessarily evolved to handle the emergence of such agents, and changes in behavior toward the skin have further affected the stratum corneum's physical integrity.

The main source of concern is not the conspicuously harmful substances like industrial/cleaning chemicals, pollutants and wastes. Instead, what are most worrisome are the substances that humans and animals are exposed to on such a regular uncontrolled basis that their potential negative impact on bodily systems is slighted, especially in the long term. With regards to this, the area of most concern is the cosmetic and personal care industry. The cosmetic and personal care industries generally downplay their products' and services' potential effects on a full bodily system, and instead focus on limited and local effects to the skin only, with the stratum corneum providing a barrier for filtering and/or blocking any potentially harmful ingredients.

While the stratum corneum is considered a fairly effective barrier, it is not impervious and many factors can limit or neutralize the effectiveness of the protection offered by the stratum corneum. The actual ability of the stratum corneum to effectively filter or block external agents is dynamic and fluctuating, not static and predictable. Skin is a complex organ with a multitude of distinct structures, each contributing their own function and purpose and there are a number of factors can compromise or inhibit the ability of the skin to act as a barrier.

Dermal Decontamination: skin washing changes the barrier function of skin, both immediately and hours after washing. “Rubbing” and “solvent” washing alter/remove the lipids and cells that give the stratum corneum its barrier properties, thus increasing the potential for the percutaneous absorption of topical compounds applied after washing. Additionally, rubbing and washing can actually accelerate the absorption of a portion of compounds already present on the skin (because of the act of “rubbing”, which physically manipulates the stratum corneum and pushes compounds deeper).

Artificial (Chemically- and/or Physically-Induced) Exfoliation: one of the most popular and prevalent human skin care processes is exfoliation. Exfoliation can be performed either by physical or chemical means, in either a gentle or aggressive manner, for the face and/or body. With so much emphasis on exfoliation, human skin is being subjected to repeated and premature stripping, which heavily disrupts and compromises the stratum corneum's barrier function. As cosmetic and personal care products are applied subsequent to exfoliation, the amount of the applied compound that is being percutaneously absorbed increases dramatically (as opposed to the amount that would be absorbed by un-exfoliated skin), and thus the opportunity for systemic absorption and response also increases dramatically.

Environmental Damage: environmentally-induced damage such as burns (temperature, wind, UV, etc), wounds and short/long-term sun exposure all affect the barrier function of the stratum corneum and the overall behavior of skin; thus, all affect percutaneous absorption and potentially increase the systemic absorption of and reaction to various topical compounds such as those found in cosmetics and skin care products.

In addition, other factors such as age, overall health, ethnicity, geography, etc. can also have a deleterious effect on the ability of the stratum corneum to act as a barrier to topically applied substances. Accordingly, the reliable and effective measure of biological protection offered by the skin has become an increasingly uncertain and potentially faulty system. Human and animal bodies are being subjected to external agents of questionable safety and reactivity on a progressively expansive scale and those agents can exert undesirable biological responses not only locally in the skin, but also, when internalized, systemically throughout the entire body.

Given the possibility of a compromised stratum corneum, coupled with the increasingly varied and complex nature of the products offered by the cosmetic and skin care industry, it may be useful to consider the types of compounds being introduced to the body and the possible effects that a certain process for the formulation of these products may have on the biological functions of both human and animal organisms.

“Chiral” is derived from the Greek work meaning “hand” and all molecules exist in both a left-handed and a right-handed form. Like the hands of a human being, the molecules are perfect mirrored images of each other, making them exact opposites. The “chirality” or “handedness” of a mirror compound is described in chemistry by using the term “L” to define the left side of a molecular twin (the L-Isomer) and the term “D” to define the right side or the D-Isomer. Chirality is of interest because of its application to stereochemistry in inorganic chemistry, organic chemistry, physical chemistry, biochemistry and supramolecular chemistry.

Accordingly, the term “chiral” is generally used to describe an object that is non-superimposable on its mirror image. A molecule is chiral if it cannot be superimposed on its mirror image; the two mirror images of such a molecule are referred to as enantiomers and a mixture of equal amounts of the two enantiomers is said to be a racemic mixture. A molecule is achiral (not chiral) if and only if it has an axis of improper rotation; that is, an n-fold rotation (rotation by 360°/n) followed by a reflection in the plane perpendicular to this axis, which maps the molecule onto itself. A chiral molecule is not necessarily asymmetric, that is completely devoid of any symmetry elements, as it can have, for example, rotational symmetry.

In contrast to the two separate enantiomers, which generally have identical physical properties, a racemic mixture, or “racemate,” often has different properties compared to either one of the pure enantiomers. Different melting points and solubilities are very common, but different boiling points are also possible. The first known racemate was racemic acid, which Louis Pasteur found to be a mixture of the two enantiomeric isomers of tartaric acids.

In the world of pharmaceuticals, various compounds may be available as a racemate or as pure enantiomer, which might also have different potencies. While molecules of one “hand” are necessary to life, such as L-amino acids and D-sugars, scientists have learned that their mirror image or opposite “hand” will usually exhibit different characteristics, ranging from harmless to toxic or, in certain extreme cases, highly poisonous. Accordingly, current “best practice” standards for preparing compounds for ingestion by humans and animals dictate that both enantiomers be tested separately for their pharmacological effects. This is because many racemic compounds, when ingested by humans and/or animals, may have extremely harmful effects and lead to undesired conditions such as cancer.

Such was the case in the 1950's, with the introduction and widespread use of the chirally “incorrect” pharmaceutical known as Thalidomide. In 1979 when the chemistry of the drug was finally resolved from a chiral perspective, it was discovered that the left hand or L-form caused birth defects, while the right hand or D-form and the racemic DL-form both exhibited equal sedative ability.

Another example of the potential undesirable effects of certain racemic compounds is methamphetamine, which is commonly available by prescription under the brand name Desoxyn. The active component of Desoxyn is dextro-methamphetamine hydrochloride, which is the right-hand isomer of methamphetamine. The left-handed isomer of methamphetamine, levo-methamphetamine, is less centrally acting and more peripherally acting; therefore a racemic mixture of dextro/levo-methamphetamine isn't used in current medical practice. In the past, due to different levels of restrictions on precursor chemicals and lack of knowledge by those preparing the final product, racemic methamphetamine was produced and sold. Newer techniques typically use asymmetric synthesis methods, thereby yielding mostly dextro-methamphetamine and relatively little levo-methamphetamine.

However, even within the present standards for production of certain compounds such as pharmaceuticals, the effects of racemic compounds are not always fully considered. For example, many topically applied compounds such as skin creams and cleansers; skin lotions and suntan lotions are not presently manufactured with an eye towards ensuring chirally correct formulations. Since these compounds are not designed to be ingested or internalized, the chiral properties of these compounds have been generally downplayed or simply ignored. Accordingly, it is possible that the use of manufactured ingredients include with or added to these topically applied compounds such as vitamin A and vitamin D may be chirally incorrect. Exposure to these compounds via incidental or accidental internalization may lead to undesirable and potentially serious side effects, particularly as these chirally incorrect compounds accumulate in the body over time.

For example, lipstick is a commonly applied compound that is most certainly internalized, to one degree or another, by both women and men on a regular basis. While internalizing a small amount of lipstick is most likely relatively harmless, regardless of the racemic nature of the ingredients, the accumulation of racemic compounds over time may not be so benign. Similarly, pets such as dogs and cats may occasionally internalize topically applied compounds during their normal interaction with humans and the day-to-day grooming process that typically involves licking the skin.

Additionally, young children are known for their propensity to place all manner of objects into their mouths, including thumbs and other appendages, which may have been previously treated with a cream, lotion or other product containing chirally incorrect ingredients. Even though many of these compounds are tested and considered “safe” and “non-toxic,” that determination is not made on the basis of chirality but rather the known toxic effects associated with the chemical compounds, regardless of the chiral composition.

While a single limited exposure due to the internalization of chirally incorrect ingredients is unlikely to cause significant harm, it is possible that the accumulation of chirally incorrect compounds inside the body over a period of time due to the incidental, inadvertent or accidental internalization may prove damaging to various biological functions. Given the lack of attention paid to this issue, it is highly likely that most, if not all, humans and pets are exposed to chirally incorrect ingredients in the normal course of their daily activities.

Accordingly, without improved processes and products that minimize the inadvertent, accidental and/or incidental internalization of chirally incorrect compounds, particularly over time, the deleterious effects of exposure to and internalization of chirally incorrect compounds may become more of a concern.

### BRIEF SUMMARY OF THE INVENTION

As disclosed herein, a series of compounds that are not generally intended for internalization such as cosmetic and skin care products are formulated using chirally correct components, organic ingredients, and natural or naturally derived ingredients. In this fashion, any deleterious biological effects due to inadvertent or incidental internalization may be reduced or minimized to a greater extent. The chirally correct formulations may be used in various types of skin creams, cleansers, lotions, etc. that are formulated for application to the external surfaces of a biological entity, including humans and animals. In addition to the use of chirally correct ingredients, other formulations include additional natural and/or organic ingredients.

### BRIEF DESCRIPTION OF DRAWINGS

The preferred embodiments of the present invention will hereinafter be described in conjunction with the appended drawings, wherein like designations denote like elements, and:

FIG. 1 is a flow chart for formulating compounds for reducing or minimizing the potentially deleterious effects of racemic ingredients using chirally correct ingredients and/or natural ingredients, and/or organic ingredients in accordance with a preferred embodiment of the present invention.

### DETAILED DESCRIPTION

Descriptive Terminology Used in This Application. For purposes of further identifying and describing the various preferred embodiments of the present invention, the following terms and phrases shall have the meaning set forth below.

“Undesirable biological response” is defined as any event in which normal bodily function is impaired due to a reaction to a single chemical or a compound of chemicals, in rapid or prolonged progression, in mild or severe manifestation.

“Internalization” is defined as the movement of any external agent (natural or synthetic) into the internal body. This includes primary pathways of internalization through the skin as well as secondary pathways of internalization such as consumption/ingestion and inhalation.

The “internal body” shall include every structure, system and organ involved in the biological responses that make possible normal bodily function, and includes (but is not limited to) the skin, vascular system, respiratory system, and digestive track. With regards to the skin, an agent will not be considered in the internal body until it has passed through the stratum corneum, which, due to its relatively inert and non-living composition, is not directly involved in normal bodily function.

“Reduce the risk” shall mean a reduction in the magnitude and severity of potential risks associated with the internalization of a non-pharmaceutical or food-grade compound. Reduction of risk is an important concept, given that almost any agent available to biological organisms can be potentially harmful or toxic, depending on its usage, duration of exposure, and amount of exposure. Additionally, reduction of risk is not confined to a specific class or classification of agents, whether or not completely natural or synthetic, as virtually all agents have a limit to their safety, either immediately or associated with intermittent, short-term, or with prolonged exposure.

Organic vs. Non-Organic Ingredients. The most preferred embodiments of the present invention also incorporate organic ingredients, to the extent practicable. The United States Department of Agriculture (USDA) defines “organic” to mean foods whose ingredients cannot have been made by using most synthetic fertilizers and pesticides, genetic engineering, growth hormones, irradiation or antibiotics.

It is estimated that by using a normal complement of body and skin care products, the average woman applies more than 200 chemicals to her skin each day. Furthermore, recent research has shown that as much 60% of these chemical ingredients are absorbed into the bloodstream. It has also been found that the number of people with eczema, allergies and skin complaints is on the rise, with these conditions most likely being aggravated by the chemicals in basic cosmetic and skincare products.

Many skin care products contain known or suspected carcinogens, neurotoxins and hormone disruptors. Additionally, as known by those skilled in the art, synthetic as well as natural fragrances are frequently allergenic to a certain segment of the populace. Further, some ingredients, like lanolin, which comes from sheep's wool, can be contaminated with pesticides. Other chemicals used in formulating skin care products can interact with nitrites to form carcinogens called nitrosamines.

The best way to prevent potentially harmful synthetic and natural chemicals from entering the body is to use only organic materials. Regulations governing organically grown compounds also prohibit the use of genetically modified ingredients. If a product claims it's organic, it must contain at least 95 percent of organically grown produce. For a product to claim that it has been ‘made with organic ingredients’, it must contain over 70 percent of organically grown ingredients.

The skin is the largest organ in your body. It is responsible for maintaining the correct body temperature and it regulates your body's fluid balance. Each day through many hundreds of thousands of skin pores, the average human secretes over 850 ml of fluid. The same glands are also an essential route for the elimination of toxins collected via the blood and lymphatic system. Blocking the skin could force the waste back inside the system. The skin functions as a nutritional factory, producing vitamin D, necessary in the formation of bone, and participates in the metabolism of carbohydrates and amino acids. It is important to remember, that the skin is a living part of your body—often referred to as the ‘third kidney’—with several well-developed and interrelated circulation systems; blood, sweat, sebum, nerve and lymph, any of which can be damaged by absorption of chemicals or enhanced by a good skin care system.

Two major leading causes of allergy and irritation in skin care products are fragrances and preservatives. Other commonly reported symptoms include nausea, mood changes, depression, lethargy, restlessness, irritability, memory lapses and inability to concentrate. Many chemicals found in fragrances are commonly designated as hazardous components in other products. Manufactures are not required to list on product labels the ingredients used in formulating their fragrances, scents or perfumes and it is estimated that 95% of the ingredients in most fragrances are made from synthetic chemicals. While fragrances made with all natural ingredients can also cause skin irritation, it is less likely to occur.

Cosmetic products require preservatives or bactericides to prevent them from being contaminated. Some of the most allergenic and irritating preservatives release small amounts of formaldehyde, which is an irritant as well as a carcinogen and neurotoxin.

Many skin care products, both natural and from mainstream companies, contain either diethanolamine or triethanolamine (wetting agents), abbreviated on labels as DEA and TEA, and sometimes shown bound to other compounds as in cocamide DEA, TEA or sodium lauryl sulfate. Neither DEA nor TEA is carcinogenic. However, if these products also contain nitrites—often present as contaminants and not disclosed on cosmetic labels, their presence in cosmetics can cause a chemical reaction leading to the formation of nitrosamines, with many nitrosamines viewed as carcinogenic or potentially carcinogenic compounds.

A group of preservatives called Parabens are also causing concern due to their oestrogen-mimicking properties. There are four main types of Parabens, these being butyl-paraben, ethyl-paraben, methyl-paraben and propyl-paraben. When consumed orally, the human body seems capable of disarming these agents and preventing them from significantly altering the natural hormone levels. However, when these same ingredients are absorbed through the skin, they appear to be far more active. A recent study found higher than normal concentrations of Parabens in human breast tumor tissue. Elevated oestrogen levels are thought to be a primary factor for increasing the risk of breast cancer, and the discovery of oestrogen-mimicking compounds in cancer tissue. The researchers have suggested that the use of Parabens in underarm deodorants may, particularly when used after shaving, be a contributory factor in the increasing number of breast cancer cases. In addition to the above risk, exposure to Propyl-paraben has been shown to reduce daily sperm production in men. Although the reason for this action is unknown, it would seem prudent for both men and women to avoid unnecessary contact with Parabens until their safety is confirmed.

Natural vs. Synthetic Ingredients. There is much debate about where “natural” stops and “synthetic” begins with regards to cosmetic and personal care ingredients. Unfortunately, there is no universally accepted definition for either class of ingredients. For the purpose of this patent application and the various preferred embodiments of the present invention, “natural” and “synthetic” will be defined as set forth below.

Natural: Shall include the following—
a) Any material derived from a natural living or non-living source that remains chemically unchanged from its naturally existing state. Extraction of such material by means of mechanical manipulation (such as grinding, powderizing, physical filtration, etc) or naturally derived solvents (such as carbon dioxide, water, oils, etc) is acceptable as long as the original chemical structure is preserved.
b) An extract of a compound existing in nature that is either chemically or mechanically processed, but whose natural chemical structure is preserved (i.e. tetrahydrocurcuminoids is a specific example of a natural chemical constituent extracted from turmeric root).
c) A compound derived by mechanically mixing two or more inert compounds existing in nature together, by which no chemical reaction occurs.
d) A compound derived by mechanically mixing two or more compounds existing in nature together, by which a chemical reaction naturally occurs with no introduction of non-natural compounds.
e) Any material, synthesized or not, whose exact chemical structure exists in nature. It is important to accept ingredients that are synthesized to identically mirror natural compounds as “natural” because: i) it is not always possible to obtain raw materials right from nature at reasonable prices and with commercially reliable availability; and ii) if the ingredients are chemically identical to the ingredient in its natural state, then there is no practical difference.

Synthetic: Shall include the following—
a) Any chemical or compound chemically synthesized and manufactured “from scratch” in a laboratory or industrial setting whose chemical structure does not and cannot match anything found in nature.
b) Any chemical or compound that has been created by the chemical manipulation of one or more natural materials in a laboratory or industrial setting whose final chemical structure does not and cannot match anything found in nature.
c) A chemical or compound that has been chemically synthesized and manufactured to “copy” a natural material, but is left in its racemic form (i.e. it is not put through a chiral separation process to isolate the appropriate when it should be).

Several examples of the use of racemic compounds will offer additional background as to the practical implications of the current practices in the cosmetics and skin care industries. For example, 1-alpha bisabolol, also known as levomenol, is a colorless viscous oil that is the primary constituent of the essential oil derived from German chamomile (Matricaria recutita). It is almost insoluble in water and glycerin, but well soluble in ethanol. Bisabolol is also known to have various anti-irritant, anti-inflammatory and anti-microbial properties. Bisabolol also has a weak sweet floral aroma and is used in various fragrances. It has also been used for hundreds of years in cosmetics because of its perceived skin healing properties. In laboratory synthesis, the molecule that matches the natural form of bisabolol is the left-handed molecule but the synthetic version of bisabolol, typically used in cosmetics, is a racemic mixture.

Similarly, the natural form of vitamin E is the d-alpha tocopherol molecule. The laboratory-synthesized molecule that matches the naturally occurring form is also the right-handed (d) version. With many cosmetic and skin care products advertised as containing vitamin E, the inclusion of the non-natural, “racemic” molecule is common. This version is the dl tocopherol version and has been known to cause allergic reactions in some people. Only the split “d” molecule mirrors the natural version but it is common to see the racemic version used in various formulations for products designed for use by humans.

Panthenol, also known as Vitamin B5, comes in two enantiomers, the D and L versions. While only D-panthenol (dexpantheno is considered biologically active, both forms are known to have moisturizing properties. For cosmetic use, panthenol comes either in the D form, or as a racemic mixture containing both the D and L enantiomers (dl-panthenol). The racemic version is commonly used in the cosmetic and skin care industry for a variety of topically applied products.

Given the broad scope of the present invention, it would be useful to present several examples of specific formulations and methods of manufacture that may be considered illustrative but not limiting in the explanation of certain preferred embodiments of the present invention. The examples shown below are only two of the many products that could be formulated using the concepts and methods of the present invention.

Facial Cleanser Formulation. This is a formula and manufacturing process for a facial cleanser in accordance with a preferred embodiment of the present invention. Part A—In a glass beaker, bring 3220 gm. of treated water to a temperature of 80° centigrade. Add 0.1 gm. Biotin and 2 gm. of Aloe Powder and 1 gm. of Potassium Sorbate and 40 gm. Structure XL and 10 gm. of Methocel 10-101 Powder. Place Part A into a standard mixer on low speed.

Part B—Mix together 511 gm. Ricinoleamidopropyl Betaine with 439 gm. Ritafactant 138 AN (Deecyl Glucoside, Sodium Lauroyl Lactylate) and 5 gm. D-Panthenol and 11 gm. L-Bisabolol and 10.8 gm. D-Alpha Tocopherol. Add part B into part A while the mixer is on low speed.

Part C—Mix together 135.6 gm. Sorbitol with 1.2 gm. Octaquest E-30 and 30 gm. % STAIL (Phenethyl Alcohol 58% and Caprylyl Glycol 42% Conc.). Mix part C into previously combined part A and part B.

Skin Lotion Formulation. This is a formula and manufacturing process for a skin lotion cleanser in accordance with a preferred embodiment of the present invention. Part A—Heat 3,250 ml of treated water to 85° degree centigrade and add 4 gm. L-Sodium Hyaluronate. After the Hyaluronate has dissolved, add 2 gm. Potassium Sorbate and mix well. Then, in a glass bowl add 80 ml Glycerin with 16 gm. Xanthan Gum to make a paste and combine with liquid ingredients.

Part B—Combine 320 gm. Oliven 1000 (B&T) with 371.6 gm. Myristol 318 (Caprylic/Capric Triglyceride) and 81 gm. Jojoba Oil. Heat combined ingredients to 85° centigrade.

Use a 4-inch dispersion blade and combine A with part B and mix together for 25 minutes. Follow this with a regular cool bath process and add the following ingredients at 40 degree centigrade 40 ml D-Vitamin E (D-Tocopherol)(Covitol IK00069) and 40 gm D-Panthenol and 20 gm L-Alpha Bisabolol and 0.2 gm Biotin and 50 ml Treated Water and 48 gm Stabil and 2 ml Octaquest E-30 (EDDS).

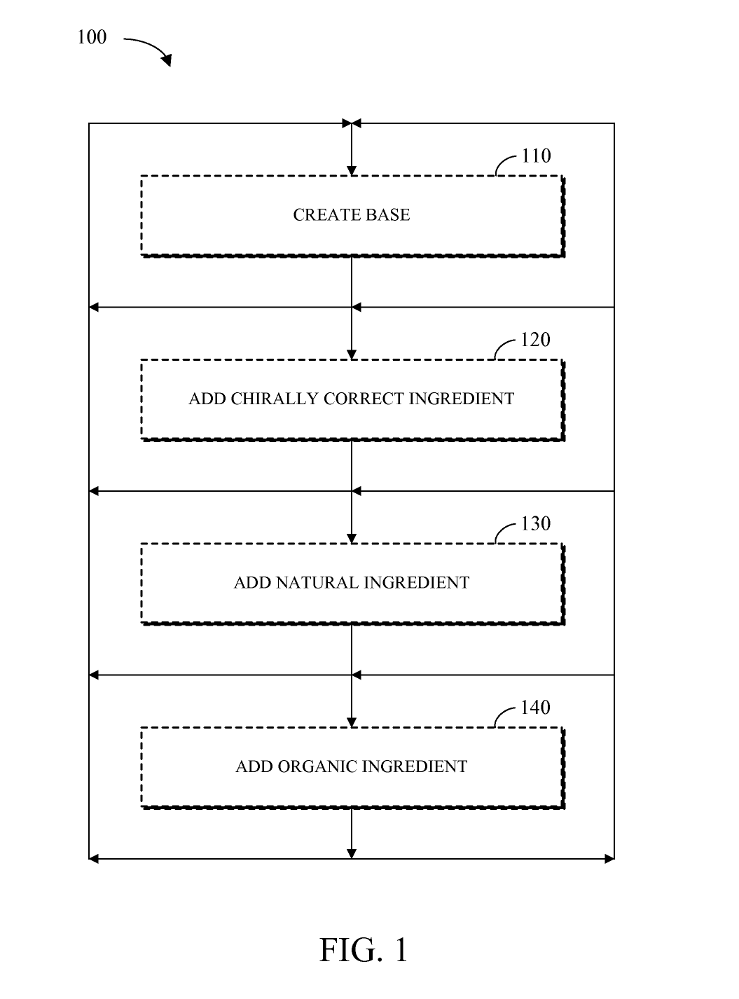

Referring now to FIG. 1, a flow chart for formulating compounds in accordance with the preferred embodiments of the present invention is depicted. As shown in FIG. 1, typically, a base for the formulation is created (STEP 110). This base may be a liquid, such as purified or treated water, and may include other ingredients such as oil. Next, one or more chirally correct ingredients can be added (STEP 120), if desired. Next, one or more natural ingredients can be added (STEP 130), if desired. Finally, one or more organic ingredients can be added (STEP 140), if desired. Those skilled in the art will also recognize that the process set forth in FIG. 1 is intended to create product formulations that are less likely to cause undesirable biological responses, allergic reactions, etc.

As shown in FIG. 1, it is possible to include any and/or all of the various components, in any order, as may be required for the specific product formulation. Those skilled in the art will also recognize that, in at least some cases, the exact order of adding the various ingredients may be altered without materially affecting the outcome of the manufacturing process.

Accordingly, those skilled in the art will recognize that the unique combinations of ingredients set forth herein are selected so as to be the healthiest and chemically benign components possible for use in cosmetic and skin care applications. It should also be noted that the various preferred embodiments of the present invention are not directed towards preventing or eliminating all potential risks associated with internalization of racemic compounds. Rather, the methods of the present invention are directed towards reducing and minimizing toxicity or harmfulness, particularly with regards to long-term exposure due to inadvertent or accidental exposure to racemic compounds and agents that may produce undesired biological responses, as well as non-natural and non-organic compounds with unknown effect on the biological system of humans and animals.

Lastly, it should be appreciated that these embodiments are preferred exemplary embodiments only, and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. A method of formulating a non-pharmaceutical topically applied product, the method comprising the steps of:
creating a base for the skin care product;
adding at least one chirally correct ingredient;
adding at least one organic ingredient; and
adding at least one natural ingredient.

2. The method of claim 1 wherein the topically applied product is a topically applied product formulated for animals.

3. The method of claim 1 wherein the topically applied product is a topically applied cosmetic product for humans.

4. The method of claim 1 wherein the topically applied product is a topically applied skin care product for humans.
